(19) United States
(12) Patent Application Publication
(10) Pub. No.: US 2023/0038651 A1
(43) Pub. Date: Feb. 9, 2023

(54) ENVIRONMENTALLY FRIENDLY PHOTORESIST REMOVING COMPOSITION AND METHOD FOR USING THE SAME

(71) Applicant: Yuanhan Materials Inc., Taipei City (TW)

(72) Inventors: Sheng-Chun SHA, Taipei City (TW); Hung-Chun YU, Taipei City (TW); Feng-Chao YU, Taipei City (TW); En-Ming CHANG, Taipei City (TW)

(21) Appl. No.: 17/814,534

(22) Filed: Jul. 25, 2022

Related U.S. Application Data
(60) Provisional application No. 63/226,168, filed on Jul. 27, 2021.

(51) Int. Cl. G03C 1/74; C11D 3/10; C11D 1/40; C11D 3/20

(52) U.S. Cl. CPC G03C 1/74; C11D 3/10; C11D 1/40; C11D 3/2068; G03C 2001/7429

(57) ABSTRACT

An environmentally friendly photoresist removing composition includes 20 parts by weight to 80 parts by weight of a carbonate compound, 0.5 parts by weight to 15 parts by weight of a hydramine compound, an amide compound, or an ammonium compound, 1 part by weight to 20 parts by weight of an organic base compound, and 2 parts by weight to 70 parts by weight of an alcohol ether compound.

### RELATED APPLICATION

This application claims priority to U.S. Provisional Application Ser. No. 63/226,168, filed Jul. 27, 2021, which is herein incorporated by reference.

### BACKGROUND

### Field of Invention

The present disclosure relates to an environmentally friendly photoresist removing composition and a method for using the environmentally friendly photoresist.

### Description of Related Art

In the electronic industry, photoresist is often used as a photosensitive material and is widely used in the production of circuit patterns, photoresist is mainly obtained by mixing resins, sensitizers, and solvent, in which acrylic is a common photoresist resin. Photoresist currently used can be classified into positive-type photoresist and negative-type photoresist. The characteristic of the positive-type photoresist is that the portion thereof irradiated by light will dissolve in the photoresist developer, while the portion thereof not irradiated will not dissolve in the photoresist developer; on the other hand, the characteristic of the negative-type photoresist is that the portion thereof irradiated by light will not dissolve in the photoresist developer, while the portion thereof not irradiated will dissolve in the photoresist developer. After the circuit patterns are fabricated, the photoresist needs to be removed for the next process. Nowadays, the ingredients of the commonly used photoresist removers on the market are complex, and in order to dissolve the complex ingredients, additional water is often required to be added to the photoresist remover, resulting in a complicated and tedious subsequent waste liquid treatment, which is not conducive to environmental protection. In addition, common photoresist removers on the market often contain highly toxic ingredients, which lead to the generation of pollutants and odors. Therefore, how to provide an environmentally friendly photoresist removing composition is an important issue in this field.

### SUMMARY

According to some embodiments of the present disclosure, an environmentally friendly photoresist removing composition includes 20 parts by weight to 80 parts by weight of a carbonate compound, 0.5 parts by weight to 15 parts by weight of a hydramine compound, an amide compound, or an ammonium compound, 1 part by weight to 20 parts by weight of an organic base compound, and 2 parts by weight to 70 parts by weight of an alcohol ether compound.

In some embodiments of the present disclosure, the carbonate compound includes propylene carbonate, ethylene carbonate, butylene carbonate, or combinations thereof.

In some embodiments of the present disclosure, the hydramine compound includes ethanolamine, diethanolamine, triethanolamine, or combinations thereof, and the ammonium compound includes benzyltrimethylammonium hydroxide.

In some embodiments of the present disclosure, the amide compound includes betaine, sodium dodecylpoly(oxyethylene) sulfate, or a combination thereof.

In some embodiments of the present disclosure, the organic base compound includes methylamine, ethylene diamine, triethylamine, or combinations thereof.

In some embodiments of the present disclosure, the alcohol ether compound includes ethylene glycol monobutyl ether, butyl carbitol, propylene glycol monomethyl ether, propylene glycol methyl ether acetate, or combinations thereof.

According to some other embodiments of the present disclosure, an environmentally friendly photoresist removing composition is composed of the following reagents: 20 parts by weight to 80 parts by weight of a carbonate compound; 0.5 parts by weight to 15 parts by weight of a hydramine compound, an amide compound, or an ammonium compound; 1 part by weight to 20 parts by weight of an organic base compound; and 2 parts by weight to 70 parts by weight of an alcohol ether compound.

In some embodiments of the present disclosure, the carbonate compound is at least one selected from the group consisting of propylene carbonate, ethylene carbonate, and butylene carbonate.

In some embodiments of the present disclosure, the hydramine compound is at least one selected from the group consisting of ethanolamine, diethanolamine, and triethanolamine, and the ammonium compound is benzyltrimethylammonium hydroxide.

In some embodiments of the present disclosure, the amide compound is at least one selected from the group consisting of betaine and sodium dodecylpoly(oxyethylene) sulfate.

In some embodiments of the present disclosure, the organic base compound is at least one selected from the group consisting of methylamine, ethylene diamine, and triethylamine.

In some embodiments of the present disclosure, the alcohol ether compound is at least one selected from the group consisting of ethylene glycol monobutyl ether, butyl carbitol, propylene glycol monomethyl ether, and propylene glycol methyl ether acetate.

According to some other embodiments of the present disclosure, a method for using an environmentally friendly photoresist removing composition includes: performing a cleaning step, which includes spraying the environmentally friendly photoresist removing composition according to any one of claims 1 to 12 on the object to be cleaned which is covered by a photoresist, such that the photoresist is removed, wherein the cleaning step is carried out at a temperature of 40° C. to 70° C.

In some embodiments of the present disclosure, the cleaning step is carried out under an alkaline condition.

In some embodiments of the present disclosure, a pH value of the alkaline condition is between 10 and 12.

In the aforementioned embodiments of the present disclosure, since the environmentally friendly photoresist removing composition of the present disclosure includes an appropriate amount of the carbonate compound, at least one of the hydramine compound, amide compound, and ammonium compound, organic base compound, and alcohol ether compound, each ingredient can synergize with each other for efficient photoresist removal at lower temperature. In addition, since the environmentally friendly photoresist removing composition of the present disclosure does not contain water, it can avoid the tedious process of waste liquid treatment after used, thereby effectively reducing costs of waste liquid treatment and improving environmental friendliness. In addition, compared with the traditional photoresist remover, the photoresist removing composition of the present disclosure does not require the use of highly toxic chemicals, thereby reducing the generation of pollutants and odors.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The present disclosure provides at least one environmentally friendly photoresist removing composition (also referred to as a photoresist removing composition hereinafter) which can remove many photoresists currently widely used (e.g., photoresist for semiconductor packaging or photoresist for panels, etc.). The photoresist removing composition of the present disclosure can not only remove photoresist efficiently at a relatively low temperature (for example, about 40° C. to 70° C.), but also can avoid the tedious process of waste liquid treatment after used, thereby effectively reducing costs of waste liquid treatment and improving environmental friendliness. In addition, compared with the traditional photoresist remover, the photoresist removing composition of the present disclosure does not require the use of highly toxic chemicals, thereby reducing the generation of pollutants and odors.

It is supplemented that some specific embodiments of the photoresist for semiconductor packaging or the photoresist for a panel can be, for example, an acrylic resin photoresist containing a positive-type photoresist or a negative-type photoresist. That is, the photoresist removing composition of the present disclosure can dissolve acrylic resin photoresist containing positive-type or negative-type photoresist. Specifically, the positive-type photoresist can be formed from, for example, AZ series photoresist (e.g., for panels) purchased from Taiwan Merck Co., Ltd., TFR series photoresist (e.g., for thin film transistors for panels) and PMER P7100 series photoresists (e.g., for super twisted nematic liquid crystals for panels) purchased from Taiwan TOK Co., Ltd., and THB-801P (trade name) photoresist purchased from Japan JSR Corporation, while the negative-type photoresist formed from, for example, a CFPR BK series photoresist (e.g., for color filters for panel) purchased formed from Taiwan TOK Co., Ltd. Based on the above, the photoresist removing composition of the present disclosure can be used to remove many positive-type or negative-type photoresists widely used at present.

The photoresist removing composition of the present disclosure includes a carbonate compound, at least one of a hydramine compound, amide compound, and ammonium compound, an organic base compound, and an alcohol ether compound. In detail, the carbonate compound can be used to sufficiently mix and dissolve the hydramine/amide/ammonium compound, the organic base compound, and the alcohol ether compound. That is, the carbonate compound can be used as a solvent and remove acrylic resin photoresist to a certain extent; the hydramine/amide/ammonium compound can be used as a surfactant for the swelling of photoresist (e.g., in a hardened photoresist, the photoresist can swell, and the surfactant can embed into the photoresist to destroy bridging structure therein) and be used to remove liposoluble ingredients or other residual ingredients in photoresist; the organic base compound can be used to remove (destroy) major ingredients in photoresist (e.g., to remove acrylic resins); the alcohol ether compound can be used as a buffer to assist in dissolving photoresist, and can maintain the dispersibility and uniformity of each ingredient in the photoresist removing composition, which is beneficial to the removal of the photoresist, and can also prevent the photoresist that has left the surface of the object to be cleaned (for example, the surface of the wafer) from re-staining and splashing back on the surface of the object to be cleaned, that is, to avoid the re-sticking of the photoresist, such that the photoresist can be efficiently and completely removed. In general, the hydramine/amide/ammonium compound of the present disclosure can first make the photoresist swell, and then the organic base compound can peel off the swelled photoresist, while at the same time, the carbonate compound can be used to remove the photoresist and dissolve each ingredient in the photoresist, and the alcohol ether compound maintains the dispersibility and uniformity of each ingredient and prevents the photoresist from re-staining. Hence, the photoresist removing composition of the present disclosure can efficiently remove the photoresist at a lower temperature.

In the photoresist removing composition of the present disclosure, a content of the carbonate compound is between 20 parts by weight and 80 parts by weight, a content of the hydramine compound, amide compound, or ammonium compound is between 0.5 parts by weight and 15 parts by weight, a content of the organic base compound is between 1 part by weight and 20 parts by weight, and a content of the alcohol ether compound is between 2 parts by weight and 70 parts by weight. The ingredients falling within the above content ranges can synergize with each other, thereby effectively removing the photoresist. Specifically, the upper limit and lower limit of the content of each ingredient have critical significance. For the carbonate compound, when the content of the carbonate compound is less than 20 parts by weight, each ingredient (for example, at least one of the hydramine compound, amide compound, and ammonium compound, the organic base compound, and the alcohol ether compound) cannot be fully dissolved, thereby causing each ingredient to fail to exert its respective functions; when the content of the carbonate compound is greater than 80 parts by weight, the concentration of each ingredient in the photoresist removing composition may be low, resulting in that the photoresist cannot be completely removed. For the hydramine/amide/ammonium compound, when the content of the hydramine/amide/ammonium compound is less than 0.5 parts by weight, the photoresist may not swell to a sufficient extent, which may affect the removal of the photoresist, and may also cause the liposoluble ingredients or other residual ingredients in the photoresist to be incompletely removed; when the content of the hydramine/amide/ammonium compound is greater than 15 parts by weight, it may cause the hydramine/amide/ammonium compound to remain on the surface of the object to be cleaned together with the photoresist after the photoresist swelled, resulting in that the photoresist cannot be completely removed. For the organic base compound, when the content of the organic base compound is less than 1 part by weight, the main ingredients in the photoresist may not be completely removed, and the remaining minor ingredients in the photoresist together with the main ingredients in the photoresist are easily attached to the surface of the object to be cleaned; when the content of the organic base compound is greater than 20 parts by weight, the excess amount of the organic base compound may cause the carbonate compound to fail to dissolve all ingredients at the same time, thereby affecting the removal effect of the photoresist. For the alcohol ether compound, when the content of the alcohol ether compound is less than 2 parts by weight, the dispersibility and uniformity of each ingredient in the photoresist removing composition may be low, which may affect the performance of each ingredient by its respective functions, and may easily cause the photoresist to re-stain to the object to be cleaned; when the content of the alcohol ether compound is greater than 70 parts by weight, the excess alcohol ether compound may cause the carbonate compound to fail to dissolve all ingredients at the same time, thereby affecting the removal of the photoresist. In general, the content of each ingredient in the photoresist removing composition of the present disclosure is adjusted and complemented by each other, such that the photoresist can be removed efficiently in a relatively energy-saving manner. In some preferred embodiments, the content of the carbonate compound is between 30 parts by weight and 70 parts by weight (for example, 35, 40, 45, 50, 55, 60, 65 parts by weight), the content of the hydramine compound, amide compound, or ammonium compound is between 5 parts by weight and 15 parts by weight (for example, 6, 7, 8, 9, 10, 11, 12, 13, 14 parts by weight), the content of the organic base compound is 5 parts by weight, and the content of the alcohol ether compound is between 20 parts by weight and 57 parts by weight (for example, 25, 30, 35, 40, 45, 50, 55 parts by weight).

In some embodiments, the carbonate compound includes propylene carbonate, ethylene carbonate, butylene carbonate, or combinations thereof. By using the above-mentioned carbonate compound, the use of highly toxic agents (e.g., dimethyl sulfoxide, N-methylpyrrolidone, or tetramethylammonium hydroxide, etc.) in traditional photoresist removers can be avoided, thereby avoiding the high cost due to the use of toxic agents, reducing the tedious steps of disposal of toxic agents, and reducing the generation of pollutants and odors. In some preferred embodiments, the carbonate compound may be propylene carbonate, which has better solubility for each ingredient and can better remove photoresist. In some embodiments, the hydramine compound may include ethanolamine, diethanolamine, triethanolamine, or combinations thereof; and the amide compound may include betaine, sodium dodecylpoly(oxyethylene) sulfate, or a combination thereof; and the ammonium compound may include benzyltrimethylammonium hydroxide. By using the above-mentioned hydramine compound, amide compound, or ammonium compound, the photoresist removing composition of the present disclosure can swell the photoresist before removing the photoresist, so as to facilitate the removal of the photoresist, and also facilitate the removal of the liposoluble ingredients or other residual ingredients in the photoresist. In some preferred embodiments, the hydramine compound may be ethanolamine.

In some embodiments, the organic base compound includes methylamine, ethylene diamine, triethylamine, or combinations thereof. By using the above-mentioned organic base compound, the photoresist removing composition of the present disclosure can effectively remove the main ingredients in the photoresist, and thus can easily remove the remaining ingredients in the photoresist. In some preferred embodiments, the organic base compound may be ethylene diamine.

In some embodiments, the alcohol ether compound includes ethylene glycol monobutyl ether, butyl carbitol, propylene glycol monomethyl ether, propylene glycol methyl ether acetate, or combinations thereof. By using the above-mentioned alcohol ether compound, the ingredients in the photoresist removing composition of the present disclosure can have good dispersibility and uniformity, thereby facilitating the removal of the photoresist and avoiding the re-staining of the photoresist. In some preferred embodiments, the alcohol ether compound may be a combination of ethylene glycol monobutyl ether and butyl carbitol.

In general, in the photoresist removing composition of the present disclosure, each ingredient is nontoxic, and each ingredient is a compound that is easy to obtain (or make) and has relatively mild chemical properties. In this way, the photoresist removing composition can have high preparation convenience and high environmental friendliness, and does not generate odor (e.g., sulfur odor) during or after use. On the other hand, compared with commercially available photoresist removers, since the ingredients in the photoresist removing composition of the present disclosure are relatively simple, it is not easy to corrode the surface of the object to be cleaned (for example, the copper surface of the wafer). In an experiment, when trying to remove the photoresist (commodity model: AZ-3100, purchased from Merck) on the surface of wafer with the photoresist removing composition of the present disclosure, it can be found that the amount of copper ions precipitated in the waste liquid after cleaning by using the photoresist removing composition of the present disclosure is less, indicating that the photoresist removing composition of the present disclosure is indeed less likely to corrode the surface of the object to be cleaned (i.e., it is not easy to dissolve or corrode copper ions or react with copper ions on the surface of wafer surface). It is worth noting that, since the photoresist removing composition of the present disclosure does not contain any inorganic base, water does not need to be added to the photoresist removing composition, and thus avoid the tedious process of waste water treatment (for example, saving the combustion cost of waste liquid (waste water)), thereby having a great contribution to environmental protection and cost saving. In addition, the performance of the photoresist removing composition of the present disclosure in removing photoresist is as good as or even better than the performance of the commercially available photoresist remover in removing photoresist.

The present disclosure further provides an environmentally friendly photoresist removing composition, which is composed of 20 parts by weight to 80 parts by weight of the aforementioned carbonate compound, 0.5 parts by weight to 15 parts by weight of at least one of the aforementioned hydramine compound, amide compound, and ammonium compound, 1 part by weight to 20 parts by weight of the aforementioned organic base compound, and 2 parts by weight to 70 parts by weight of the aforementioned alcohol ether compound. That is, the photoresist removing composition does not include ingredients other than the above ingredients. In such embodiments, the ingredients (reagents, compositions) of the photoresist removing composition is simpler and less polluting to the environment, and for some specific types of photoresist (for example, resin photoresist including acrylic), it is enough to completely remove the photoresist. In some embodiments, the carbonate compound is at least one selected from the group consisting of propylene carbonate, ethylene carbonate, and butylene carbonate; the hydramine compound is at least one selected from the group consisting of ethanolamine, diethanolamine, and triethanolamine; the amide compound is at least one selected from the group consisting of betaine and sodium dodecylpoly(oxyethylene) sulfate; the ammonium compound is benzyltrimethylammonium hydroxide; the organic base compound is at least one selected from the group consisting of methylamine, ethylene diamine, and triethylamine; the alcohol ether compound is at least one selected from the group consisting of ethylene glycol monobutyl ether, butyl carbitol, propylene glycol monomethyl ether, and propylene glycol methyl ether acetate.

The present disclosure further provides a method for using an environmentally friendly photoresist removing composition, which includes using the aforementioned photoresist removing composition to remove photoresist on the surface of a wafer (object to be cleaned). Firstly, a wafer covered with a photoresist is provided and the aforementioned photoresist removing composition is provided. Next, a cleaning step is performed, and the photoresist removing composition is sprayed on the surface of the wafer covered with the photoresist to remove the photoresist. In some embodiments, the cleaning step is performed at a temperature of 40° C. to 70° C. For example, for a 12-inch wafer, the cleaning step is performed at a temperature of 40° C. to 70° C. for 2 minutes to 20 minutes. As mentioned above, since the photoresist removing composition of the present disclosure can provide a good photoresist removal effect, the photoresist can be completely removed without the need of high temperature and a long time. Compared with the conventional photoresist remover, which needs to be cleaned at about 90° C. for about 20 minutes (for a 12-inch wafer), the environmental protection and efficiency provided by the photoresist removing composition of the present disclosure is significantly improved. In some embodiments, the cleaning step is performed under an alkaline condition, in which the alkaline condition refers to an environment with a pH between 10 and 12. Such an alkaline condition help the photoresist removing composition of the present disclosure to maintain its stability, such that each ingredient in the photoresist removing composition can fully exert their respective functions during the cleaning process.

The features and efficacy of the present disclosure will be described in more detail below with reference to a comparative example and multiple embodiments. It should be understood that the materials used, their amounts and proportions, processing details, and processing procedures, etc. may be appropriately changed without departing from the scope of the present disclosure. Therefore, the present disclosure should not be limited by the embodiments described below. Specifically, the efficacy of the present disclosure was verified by cleaning a 12-inch wafer covered with a photoresist by the photoresist removing composition composed of a carbonate compound, at least one of a hydramine compound, amide compound, and ammonium compound, an organic base compound, and an alcohol ether compound, in which the photoresist was formed from Merck AZ-3100. Specifically, the cleaning results of the comparative example and each embodiment in Table 1 were obtained by performing the cleaning step (under a pH value of 10.5) for about 20 minutes at a temperature of 70° C., then performing a drying step for about 1 minute at a temperature of 25° C., and then observing each comparative example and each embodiment with scanning electron microscope (SEM) under the magnification of 10,000. The detailed description and cleaning results of the comparative example and each embodiment are shown in Table 1.

TABLE 1

| | | hydramine/amide/ | organic | alcohol | | |
|---|---|---|---|---|---|---|
| | carbonate | ammonium | compound | compound | cleaning results | |
| | compound | compound | base | ether | removal of | corrosion |
| | (content) | (content) | (content) | (content) | photoresist | of wafer |
| Embodiment | propylene | benzyltrimethyl- | ethylene | ethylene | Δ | no |
| 1 | carbonate | ammonium | diamine | glycol | | corrosion |
| | (20) | hydroxide | (5) | monobutyl | | |
| | | (5) | | ether | | |
| | | | | (35) | | |
| | | | | butyl | | |
| | | | | carbitol | | |
| | | | | (35) | | |
| Embodiment | propylene | ethanolamine | ethylene | ethylene | ◯ | no |
| 2 | carbonate | (8) | diamine | glycol | | corrosion |
| | (30) | | (5) | monobutyl | | |
| | | | | ether | | |
| | | | | (28) | | |
| | | | | butyl | | |
| | | | | carbitol | | |
| | | | | (29) | | |
| Embodiment | propylene | ethanolamine | ethylene | ethylene | ◯ | no |
| 3 | carbonate | (15) | diamine | glycol | | corrosion |
| | (50) | | (5) | monobutyl | | |
| | | | | ether | | |
| | | | | (15) | | |
| | | | | butyl | | |
| | | | | carbitol | | |
| | | | | (15) | | |
| Embodiment | propylene | benzyltrimethyl- | ethylene | ethylene | ◯ | no |
| 4 | carbonate | ammonium | diamine | glycol | | corrosion |
| | (70) | hydroxide | (5) | monobutyl | | |
| | | (5) | | ether | | |
| | | | | (10) | | |
| | | | | butyl | | |
| | | | | carbitol | | |
| | | | | (10) | | |
| Embodiment | propylene | benzyltrimethyl- | ethylene | ethylene | Δ | no |
| 5 | carbonate | ammonium | diamine | glycol | | corrosion |
| | (80) | hydroxide | (1) | monobutyl | | |
| | | (5) | | ether | | |
| | | | | (7) | | |
| | | | | butyl | | |
| | | | | carbitol | | |
| | | | | (7) | | |
| Comparative | propylene | ethanolamine | methylamine | ethylene | X | partial |
| Example 1 | carbonate | (10) | (5) | glycol | | corrosion |
| | (3) | | | monobutyl | | |
| | | | | ether | | |
| | | | | 82 | | |

Note 1:
removal of photoresist: ◯ No residue at all/Δ little residue/X a lot of residue
Note 2:
The unit of content of each ingredient is parts by weight

As can be seen from Table 1, Embodiments 1 to 5 use the ingredients defined in the present disclosure, and the content range of each ingredient falls within the scope defined in the present disclosure. It can be found through the cleaning results that Embodiments 1 to 5 remove the acrylic photoresist resin to a certain extent which meets the standard in the industry. Further, when the content of carbonate compound is between 30 parts by weight and 70 parts by weight, the content of hydramine/amide/ammonium compound is between 5 parts by weight and 15 parts by weight, the content of organic base compound is 5 parts by weight, and the content of the alcohol ether compound is between 20 parts by weight and 57 parts by weight, Embodiments 1 to 5 can provide an excellent removal effect on the acrylic photoresist resin. In addition, each embodiment does not cause corrosion to the wafer, thereby protecting the circuit patterns on the wafer. On the other hand, it can be seen from Comparative Example 1 that when the content of some ingredients does not fall within the range defined by the present disclosure, the photoresist removing composition cannot effectively remove the photoresist, and the wafer is more likely to be corroded.

In the aforementioned embodiments of the present disclosure, since the environmentally friendly photoresist removing composition of the present disclosure includes an appropriate amount of the carbonate compound, at least one of the hydramine compound, amide compound, and ammonium compound, organic base compound, and alcohol ether compound, each ingredient can synergize with each other for efficient photoresist removal at a lower temperature. In addition, since the environmentally friendly photoresist removing composition of the present disclosure does not contain water, it can avoid the tedious process of waste liquid treatment after used, thereby effectively reducing costs of waste liquid treatment and improving environmental friendliness. In addition, compared with the traditional photoresist remover, the photoresist removing composition of the present disclosure does not require the use of highly toxic chemicals, thereby reducing the generation of pollutants and odors.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. An environmentally friendly photoresist removing composition, comprising:
20 parts by weight to 80 parts by weight of a carbonate compound;
0.5 parts by weight to 15 parts by weight of a hydramine compound, an amide compound, or an ammonium compound;
1 part by weight to 20 parts by weight of an organic base compound; and
2 parts by weight to 70 parts by weight of an alcohol ether compound.

2. The environmentally friendly photoresist removing composition of claim 1, wherein the carbonate compound comprises propylene carbonate, ethylene carbonate, butylene carbonate, or combinations thereof.

3. The environmentally friendly photoresist removing composition of claim 1, wherein the hydramine compound comprises ethanolamine, diethanolamine, triethanolamine, or combinations thereof, and the ammonium compound comprises benzyltrimethylammonium hydroxide.

4. The environmentally friendly photoresist removing composition of claim 1, wherein the amide compound comprises betaine, sodium dodecylpoly(oxyethylene) sulfate, or a combination thereof.

5. The environmentally friendly photoresist removing composition of claim 1, wherein the organic base compound comprises methylamine, ethylene diamine, triethylamine, or combinations thereof.

6. The environmentally friendly photoresist removing composition of claim 1, wherein the alcohol ether compound comprises ethylene glycol monobutyl ether, butyl carbitol, propylene glycol monomethyl ether, propylene glycol methyl ether acetate, or combinations thereof.

7. An environmentally friendly photoresist removing composition, composed of the following reagents:
20 parts by weight to 80 parts by weight of a carbonate compound;
0.5 parts by weight to 15 parts by weight of a hydramine compound, an amide compound, or an ammonium compound;
1 part by weight to 20 parts by weight of an organic base compound; and
2 parts by weight to 70 parts by weight of an alcohol ether compound.

8. The environmentally friendly photoresist removing composition of claim 7, wherein the carbonate compound is at least one selected from the group consisting of propylene carbonate, ethylene carbonate, and butylene carbonate.

9. The environmentally friendly photoresist removing composition of claim 7, wherein the hydramine compound is at least one selected from the group consisting of ethanolamine, diethanolamine, and triethanolamine, and the ammonium compound is benzyltrimethylammonium hydroxide.

10. The environmentally friendly photoresist removing composition of claim 7, wherein the amide compound is at least one selected from the group consisting of betaine and sodium dodecylpoly(oxyethylene) sulfate.

11. The environmentally friendly photoresist removing composition of claim 7, wherein the organic base compound is at least one selected from the group consisting of methylamine, ethylene diamine, and triethylamine.

12. The environmentally friendly photoresist removing composition of claim 7, wherein the alcohol ether compound is at least one selected from the group consisting of ethylene glycol monobutyl ether, butyl carbitol, propylene glycol monomethyl ether, and propylene glycol methyl ether acetate.

13. A method for using an environmentally friendly photoresist removing composition, comprising:
performing a cleaning step, which includes spraying the environmentally friendly photoresist removing composition according to any one of claims 1 to 12 on the object to be cleaned which is covered by a photoresist, such that the photoresist is removed, wherein the cleaning step is carried out at a temperature of 40° C. to 70° C.

14. The method for using the environmentally friendly photoresist removing composition of claim 13, wherein the cleaning step is carried out under an alkaline condition.

15. The method for using the environmentally friendly photoresist removing composition of claim 14, wherein a pH value of the alkaline condition is between 10 and 12.
